(19) United States
(12) Patent Application Publication
(10) Pub. No.: US 2006/0015407 A1
(43) Pub. Date: Jan. 19, 2006

(54) Server and connection interface for establishing and controlling an IP communication

(75) Inventors: Alain Bernard, Paris (FR); Remy Didier, Saint Series (FR)

Correspondence Address: FULBRIGHT & JAWORSKI, LLP, 666 FIFTH AVE, NEW YORK, NY, 10103-3198, US

(73) Assignee: Prosodie

(21) Appl. No.: 11/175,782

(22) Filed: Jul. 5, 2005

(30) Foreign Application Priority Data
Jul. 13, 2004 (FR) 04 51504

(51) Int. Cl. G06Q 20/00

(52) U.S. Cl. 705/17

(57) ABSTRACT

The invention concerns a server connected to an Internet-type communication network, for distributing to a personal computer-type piece of computer equipment an interface that allows a user to use at least one control element to activate and deactivate a computer connection with the server and to establish an IP-type communication, the interface being such that the computer connection is activated by pressing on a push button such as a command button or a computer mouse button, the computer connection is maintained by maintaining the pressure on the push button, and the computer connection is deactivated by releasing the push button, and/or the interface being such that the computer connection is maintained by periodically pressing on a push button such as a command button or a computer mouse button.

The invention relates to a server and an interface that make it possible to establish and control an IP communication using computer equipment without requiring any dedicated hardware.

Telephony that makes use of an Internet-type computer communication network, also known as “IP (Internet Protocol) telephony,” is developing rapidly. However, this type of telephony presents a problem related to its implementation and its billing method.

IP telephony often presupposes the use of a dedicated piece of equipment intended to be connected to the computer equipment and/or to the telephone jack, thus requiring the user to make a new purchase. This dedicated hardware, often called an IP telephone, generally comprises a handset that the user hangs up at the end of a conversation.

However, IP telephony does not allow communications to be priced based on their duration when no dedicated hardware is used. This drawback is essentially linked to the fact that it is not possible to detect the end of an IP telephone conversation when the user is on his computer. He can, in fact, leave his workstation without having terminated the session. The solution that consists of opening a communication without being able to close it definitively is not viable given the risk of disputes on the part of users. Since it is impossible to determine the end of a communication, the operators in the marketplace are forced to adopt a flat-rate billing method.

The present invention solves these problems by proposing a server and an interface that make it possible to establish and control an IP communication using computing means without requiring any dedicated hardware.

The invention concerns a server connected to an Internet-type communication network, for distributing to a personal computer-type piece of computer equipment an interface that allows a user to use at least one control element to activate and deactivate a computer connection with the server and to establish an IP (Internet Protocol) type communication, particularly a voice or video conference-type communication, the interface being such that the computer connection is activated by pressing on a push button such as a command button or a computer mouse button, the computer connection is maintained by maintaining the pressure on the push button, and the computer connection is deactivated by releasing the push button, and/or the interface being such that the computer connection is maintained by periodically pressing on a push button such as a command button or a computer mouse button.

Preferably, the server is such that, in the case where the interface is such that the computer connection is maintained by periodically pressing on a push button such as a computer command button or a computer mouse button, the periodic pressure is prompted by the interface, which provides the user with an indication such as an area on the screen in which he must perform a mouse click.

Preferably, the server comprises receiving means for real-time reception from the computer equipment of information associated with the computer connection, including the activation and deactivation time of the computer connection, the IP address assigned by the Internet-type computer communication network to the computer equipment during the computer connection, and the identity of the remote operator.

Preferably, the server comprises information processing means that make it possible, based on the information associated with the computer connection, to determine a duration corresponding to the computer connection and to search for a user account associated with the computer equipment in order to assign it a debit corresponding to the computer connection.

Preferably, the server is such that the information processing means of the server make it possible to determine the user's talking time during the communication.

The invention also concerns a connection interface, distributed by a server via an Internet-type communication network to a personal computer-type piece of computer equipment, which allows a user to use at least one control element to activate and deactivate a computer connection with the server and to establish an IP (Internet Protocol) type communication, particularly a voice or video conference-type communication, the interface being such that the computer connection is activated by pressing on a push button such as a command button or a computer mouse button, the computer connection is maintained by maintaining the pressure on the push button, and the computer connection is deactivated by releasing the push button, and/or the interface being such that the computer connection is maintained by periodically pressing on a push button such as a command button or a computer mouse button.

Preferably, the connection interface is such that, in the case where the computer connection is maintained by periodically pressing on a push button such as a command button or a computer mouse button, the periodic pressure is prompted by the interface, which provides the user with an indication such as an area on the screen in which he must perform a mouse click.

Preferably, the connection interface comprises transmitting means for real-time transmission to the server of the information associated with the computer connection, including the activation and deactivation time of the computer connection, the IP address assigned by the Internet-type computer communication network to the computer equipment during the computer connection, and the identity of the remote operator.

Preferably, the connection interface comprises a means that allows the user to use the control element to activate and deactivate talking periods during the communication and to transmit to the server real-time information relative to a succession of talking periods associated with the communication.

Thus, according to a first embodiment, the active window can display a countdown (for example one minute) intended to inform the user of the end of the connection and hence the end of the payment for the payable period. If the user does not perform any specific action, the communication will terminate at the end of this countdown. If the user wishes to continue the communication, he performs a specific action for this purpose using the control element (for example a mouse click on a specific button of the active window) which has the effect of restarting the countdown. It is the same principle as a “time-out” or a “dead man's switch” on a train.

In order to ease the constraint that consists of restarting the countdown at very brief intervals (particularly one minute or less than one minute), a second embodiment consists of using the control element, particularly one of the buttons on the mouse or keyboard of the computer, or the track ball in the case of certain products, to detect an active period. Using the example of a mouse button equipped with a spring, the latter returns to its initial state when the user stops pressing on it. This mouse button can therefore be used to implement a half-duplex system (equivalent to that used in walkie-talkies) in the IP-type communication. This system consists of triggering the start of a communication by pressing down on the mouse button when the pointer of the mouse is positioned in a given area of the active window.

In order to avoid cutting off a communication in case of a micro-interruption, i.e., in the case where the user momentarily releases the pressure on the mouse button, the half-duplex system can incorporate the countdown system that is the subject of the first embodiment described above. Thus, in case of a micro-interruption, a window (particularly a “pop-up” window) appears to deliver a message such as: “You will be cut off in 20 seconds if you do not press the button again.” It is also possible to design an indicator whose color (red, orange, green) changes based on the activation of the mouse button. When the button is pressed, the indicator is green; if it is released, it changes to orange and the user has a certain amount of time, possibly adjustable, to press it again. It is the same as the “dead man's switch” system on a train.

The present invention therefore makes it possible to definitively establish the end of an IP communication. With respect to the billing of this communication, it is assumed that a user is defined by an identity. This user is given an account managed by an account manager. At a given moment, a sending IP address, which remains constant throughout the session, is associated with the identity. An Internet page appears in the user's Internet browser with a button on which may be indicated, for example, a price per minute or per second. When the user clicks on this button, which may be the size of the page, and holds the button down, he activates a service such as the possibility to speak into the microphone of the computer equipment. The moment he releases the mouse button, a “ticket” is sent to the manager of the service. The “ticket” is a record that includes the IP address of the sender, the address of the button and hence of the service it makes it possible to obtain, the date, the time, and the duration of the pressure on the mouse button. This record is sent to a manager of the service, which evaluates this ticket with the price, possibly adding it to other tickets of the same type, and sends it to the account manager for debit.

For example, the service can be a telephone service or an IP video conferencing service. It can work, as described above, by billing only for each user's talking time.

1-9. (canceled)

10. A server to an Internet-type communication network for distributing to a network accessible device an interface that allows a user to use at least one control element to activate and deactivate a computer connection with the server and to establish an Internet Protocol (IP) type communication; and wherein said interface is operable to activate said computer connection by pressing on a push button, maintain said computer connection by maintaining pressure on said push button or periodically pressing said push button, and deactivate said computer connection by releasing said push button.

11. The server of claim 10, wherein said interface is operable to prompt periodic pressure by providing an indication to said user.

12. The server of claim 11, wherein said interface is operable to provide said indication in an area on a screen of said network accessible device.

13. The server of claim 10, further comprising a receiver for receiving information associated with said computer connection in real-time from said network accessible device, said information comprising activation and deactivation time of said computer connection, an IP address assigned to said network accessible device by said communication network during said computer connection, and an identity of a remote operator.

14. The server of claim 13, further comprising a processor for determining a duration corresponding to said computer connection and searching a user account associated with said network accessible device to assign a debit corresponding to said computer connection to said user account based said information associated with said computer connection.

15. The server of claim 14, wherein said processor is operable to determine said user's talking time during said IP communication.

16. The server of claim 10, wherein said IP communication is a voice or video conference-type communication.

17. The server of claim 10, wherein said network accessible device is a personal computer and wherein said push button is a command button or a computer mouse button.

18. A connection interface, distributed by a server via an Internet-type communication network to a network accessible device, which allows a user to use at least one control element to activate and deactivate a computer connection with a server and to establish an Internet Protocol (IP) type communication; and wherein said interface is operable to activate said computer connection by pressing on a push button, maintain said computer connection by maintaining the pressure on said push button or periodically pressing said push button, and deactivate said computer connection by releasing said push button.

19. The connection interface of claim 18, wherein said interface is operable to prompt periodic pressure by providing an indication to said user.

20. The connection interface of claim 19, wherein said interface is operable to provide said indication in an area on a screen of said network accessible device.

21. The connection interface of claim 18, further comprising a transmitter for transmitting information associated with said computer connection in real-time to said server, said information comprising activation and deactivation time of said computer connection, an IP address assigned to said network accessible device by said communication network during said computer connection, and an identity of a remote operator.

22. The connection interface of claim 21, further comprising a device that enables said user to said control element to activate and deactivate talking periods during said IP communication; and wherein said transmitter is operable to transmit information relative to a succession of talking periods associated with said IP communication in real-time to said server.

23. The server of claim 18, wherein said IP communication is a voice or video conference-type communication.

24. The server of claim 18, wherein said network accessible device is a personal computer and wherein said push button is a command button or a computer mouse button.
